(19) United States
(12) Patent Application Publication
(10) Pub. No.: US 2008/0028875 A1
(43) Pub. Date: Feb. 7, 2008

(54) ELECTRONIC PIPETTE REAL-TIME RESPONSIVE TO MANUAL OPERATION

(76) Inventors: Chung-Che Lo, Sin-dlan City (TW); Hsiu-Yu Li, Sin-dlan Ctiy (TW); Shan-Yi Yen, Sin-dlan City (TW); Shan-Yung Yen, Sin-dlan City (TW); Tsai Yi Chen, Sin-dlan City (TW); Chin Kai Liao, Sin-dlan Ctiy (TW)

Correspondence Address: HDSL, 4331 STEVENS BATTLE LANE, FAIRFAX, VA, 22033, US

(21) Appl. No.: 11/748,658

(22) Filed: May 15, 2007

(30) Foreign Application Priority Data
Aug. 4, 2006 (TW) 095128632

(51) Int. Cl. B01L 3/02

(52) U.S. Cl. 73/864.11

(57) ABSTRACT

An electronic pipette real-time responsive to manual operation includes a pressing unit, a signal generator, a controller, a power unit and a drawing/draining unit. The signal generator senses a displacement stroke of the pressing unit by user and generates a displacement signal to the controller. The controller performs calculation on the displacement signal to generate a control signal for sending to the power unit. The power unit drives the drawing/draining unit according to the control signal. The amount and speed of the drawing/draining can be shown on a display of the controller.

### BACKGROUND OF THE INVENTION

1. Field of the Invention

The present invention relates to a pipette, especially to an electronic pipette.

2. Description of Prior Art

The conventional pipette is performed by manual control or electrical-mechanical control. In manual control, a pressing unit is used with two resilient elements having different resilience. Therefore, two-stage pressing operation is performed to control a pump for drawing and draining liquid. In the first pressing operation, a vacuum state is established by the pump, and the pump draws liquid when the first pressing operation is released. In the first stage of the second pressing operation, the liquid is drawn before drained. In the second stage of the second pressing operation, the remained liquid is drained with the help of injected air. In other word, the pressing force of user's hand is directly exerted for the amount and speed of drawing and draining operation for above-mentioned conventional pipette. However, the conventional pipette has considerable resistant force for the plunger and O-ring and the operation will be exerted against the resilience force of the two resilient elements. User might feel fatigue at his hand. Moreover, the drawing and draining amount cannot be precisely controller.

The conventional electronic pipettes, such as those proposed by U.S. Pat. Nos. 4,671,123, 4,905,526 and 6,254,832, use a motor with an ON/OFF switch to control a linear motor, therefore the pump is driven to draw/drain liquid and a liquid-removing unit is also driven to remove remained liquid. An adjuster is also used to set the drawing/draining amount and speed. When the start switch is pressed to turn on, the pump is controlled by motor to draw liquid by a predetermined amount and speed. When the start switch is pressed again, the pump is driven by the pump to eject the drawn liquid. Afterward the electronic pipette is back to initial state.

Other electronic pipettes are also developed, such as U.S. Pat. No. 6,959,616, where a flywheel is used with a photo detector (or photo coupler) and a pulse signal is outputted to a control circuit. The pulse signal is compared with a set pulse number and the control circuit automatically controls a power mechanism to drive the pump, and a liquid-removing unit is also driven to remove remained liquid. Moreover, an adjuster is also used to control and set drawing and draining amount.

The above-mentioned patents use electrical motor to control the electronic pipette for drawing and draining operations and liquid removing operation. However, the motor is controlled by On/Off switch. In other word, once user presses to start the motor, the electronic pipette will continue performing drawing, draining and removing liquid steps and the operation cannot be ceased. Moreover, an adjusting step is needed to control drawing and draining amount and speed control. Therefore, the above-mentioned patents are limited to the drawing and draining operation of fixed amount and speed, and cannot manually control the amount and speed of drawing and draining operation.

Moreover, U.S. Pat. No. 5,389,341 also discloses a pipette with optical detector (also referred to as optical coupler) to detect pressing operation of switch and send pulse signal to a controller circuit. The controller circuit controls a motor to drive a pump to draw and drain liquid. The controller circuit also controls a motor to drive a liquid removing unit to remove remained liquid. Moreover, an adjusting mechanism is used to control drawing and draining amount and speed control. The switches are arranged in three locations and the switches are activated only when the desired operation is needed. In other word, the control of the pipette is also based on On/Off operation. Therefore, the pipette still needs to complete all the steps (drawing, draining and removing liquid) before it stops its operation. The pipette cannot cease its operation once it is activated.

### SUMMARY OF THE INVENTION

The present invention is to provide an electronic pipette to perform a stepless drawing/draining operation, which is similar to a manual operation.

Accordingly, the present invention provides an electronic pipette real-time responsive to manual operation, comprising:

a pressing unit comprising an automatic-restoring button;

a signal generator detecting a pressing operation and a displacement amount of the button and generating a displacement signal corresponding to the displacement amount;

a controller connected to the signal generator and receiving signal from the signal generator, the controller generating a control signal based on the displacement signal;

a power unit connected to the controller and controlled by the control signal; and

a drawing/draining unit connected to the power unit to perform drawing/draining operation driven by the power unit.

The signal generator converts the stroke of pressing unit to a control signal for controlling the power unit. Therefore, the electronic pipette can produce stepless liquid drawing and draining, which similar to manual operation.

Moreover, the present invention provides a method for controlling an electronic pipette real-time responsive to manual operation, comprising:

providing an electrically-controllable drawing/draining unit;

generating a displacement signal corresponding to a manual operation;

generating a continuous control signal according to the displacement signal; and

controlling the electrically-controllable drawing/draining unit by the continuous control signal, whereby a drawing/draining amount of liquid is in proportional relationship to a stroke of the manual operation.

### BRIEF DESCRIPTION OF THE DRAWINGS

FIG. 1 shows a perspective view of the first preferred embodiment of the present invention.

FIG. 2 shows a schematic view of the first preferred embodiment of the present invention.

FIG. 3 shows an exploded view of the first preferred embodiment of the present invention.

FIG. 4 shows a sectional view of the first preferred embodiment of the present invention.

FIG. 5 shows a block diagram of the controller according to the first preferred embodiment of the present invention.

FIG. 6 shows the flowchart of the present invention.

FIG. 7 shows the flowchart of stroke detection according to a preferred embodiment of the present invention.

FIG. 8 is a schematic drawing showing the electronic pipette in stroke detection.

### DETAILED DESCRIPTION OF THE PREFERRED EMBODIMENTS

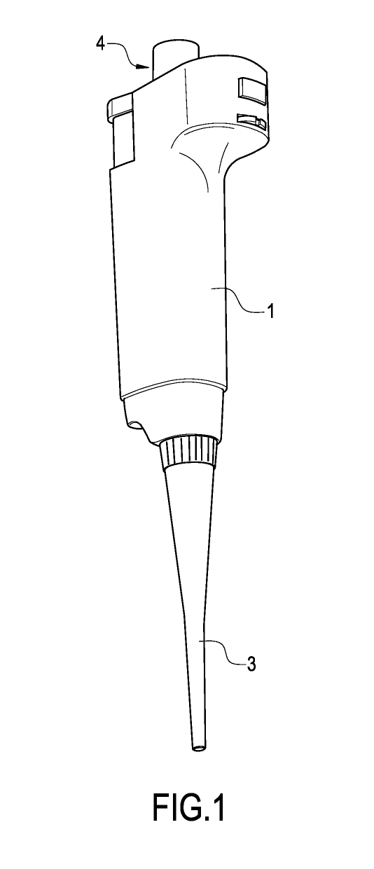

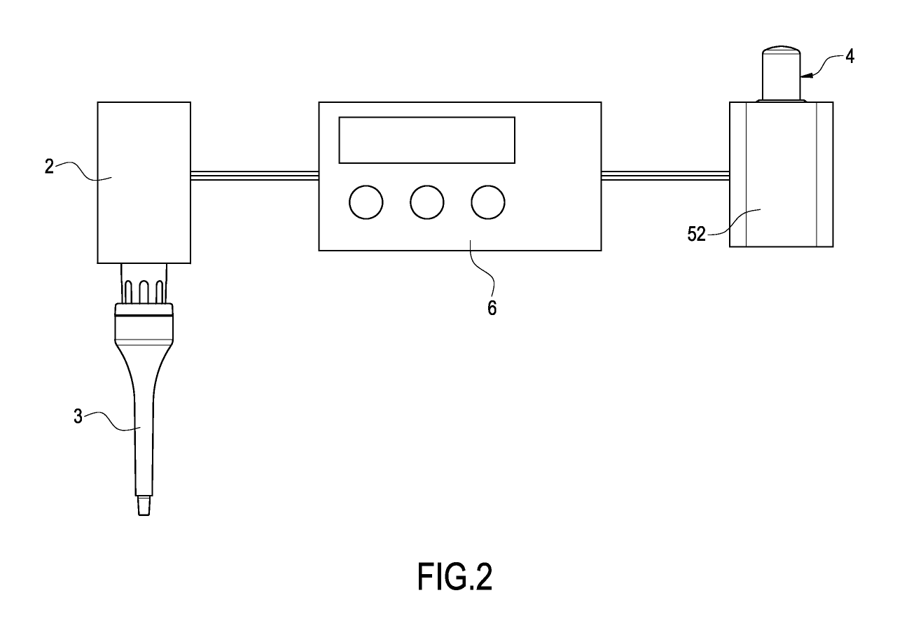

With reference to FIGS. 1 and 2, the electronic pipette real-time responsive to manual operation mainly comprises a casing 1 and a power unit 2, which is arranged in the casing 1 and provides a linear motion. A drawing/draining unit 3 is arranged on one end of the casing 1 and driven by the power unit 2. The electronic pipette further comprises a pressing unit 4, a signal generator 52 for sensing the pressing operation of the pressing unit 4 and outputting a corresponding signal. A controller 6 receives the signal output from the signal generator 52 and generates a matched control signal to the power unit 2 for driving the operation thereof, thus providing a manual pressing control. The pressing process of the pressing unit 4 is detected to know the drawing and draining operation of the power unit. Therefore, the electronic pipette has linear and stepless amount and speed control.

The power unit 2 is a linear motor for generating linear movement and comprises a telescopic axis (not shown). The power unit 2 is connected to one end of the drawing/draining unit 3 for controlling the drawing/draining operation thereof.

The drawing/draining unit 3 can be an ordinary single-straw drawing/draining unit, and can be a multiple-straw drawing/draining unit (not shown), which is connected to one end of the casing and the power unit 2.

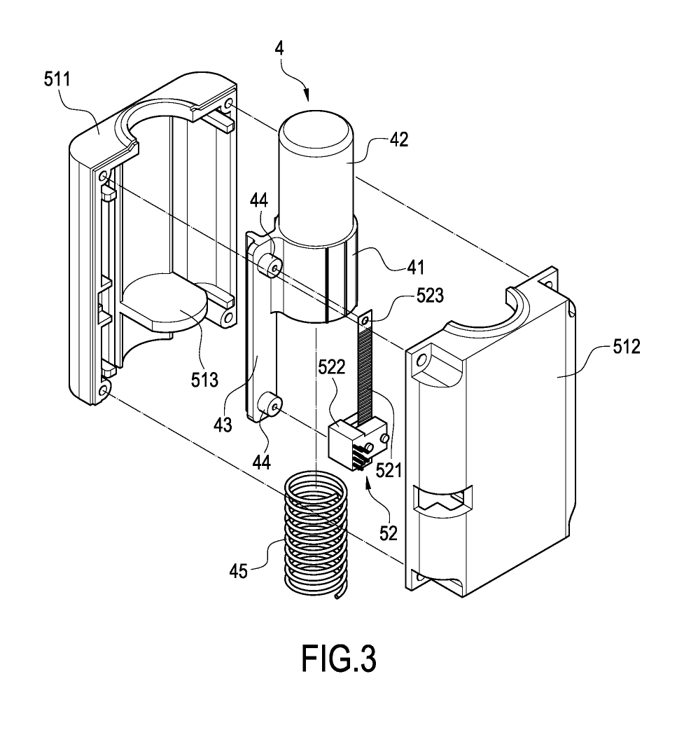

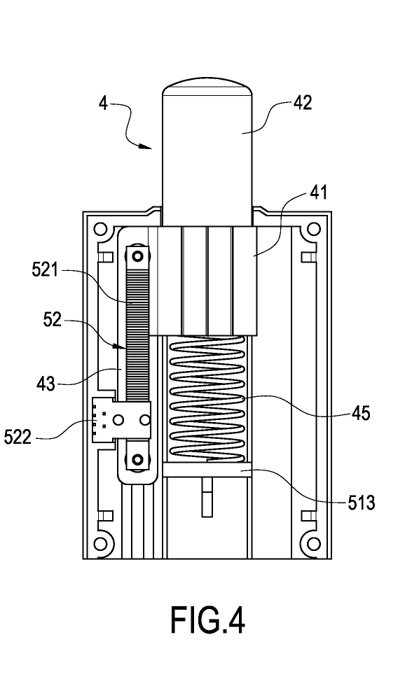

With reference to FIGS. 3 and 4, the pressing unit 4 has a movable connection with the signal generator 52 and comprises a button 42 projecting out of the casing 1. The button 42 comprises a sleeve 41 on bottom thereof and a link rod 43 on another end thereof. The link rod 43 comprises a clamping member 44 on end face thereof and coupling to the signal generator 52.

The signal generator 52 is a device for sensing a telescopic motion of the pressing unit and generating a signal corresponding to the movement of the signal generator 52. The signal generator 52 is arranging in housing, which is composed of two semi-housing 511 and 512. The pressing unit 4 and the signal generator 52 are arranged in the housing. A resilient member 45 is resiliently abutted between the bottom of the pressing unit 4 and a baffle 513 to provide resisting and restoring force to the pressing operation of the button 42. The resilient member 45 can be a compression spring.

The signal generator 52 can be preferably a displacement sensor or a pressure sensor. According to a preferred embodiment of the present invention, the signal generator 52 is a displacement sensor, where the displacement sensor can be a linear scale composed of main grating scale 521 and an optical detector 522. The main grating scale 521 comprises a clamping hole 523 for coupling to the clamping member 44 and fixed to the link rod 43, whereby the main grating scale 521 can be moved with the sleeve 41. The optical detector 522 is arranged in the casing 51 and corresponding to the link rod 43. The main grating scale 521 detects the upward and downward movement thereof by the optical detector 522, which generates a displacement signal corresponding to the movement and sends the signal to the controller 6.

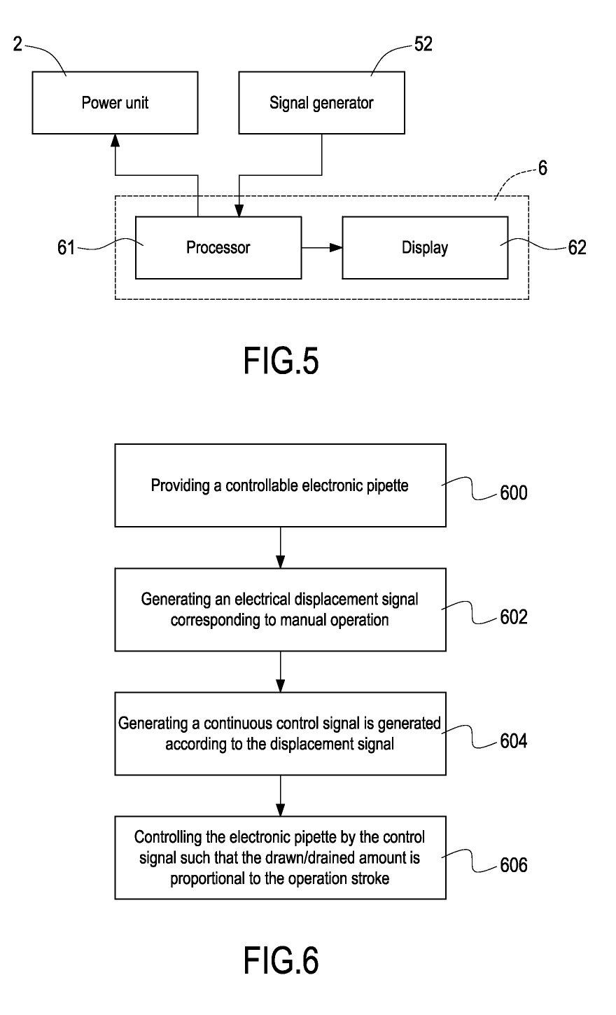

As shown in FIG. 5, the controller 6 comprises a processor 61 electrically connected to the power unit 2 and the signal generator 52, and a display 62 arranged on surface of the casing 1 and connected to the processor 61. The processor 61 calculates the drawn/drained liquid amount according to the displacement signal of the button 42, which is measured by the signal generator 52. The drawn/drained liquid amount is shown in the display 62.

FIG. 6 shows the flowchart for controlling the electronic pipette of the present invention. The steps are as follows.

Step 600: A controllable electronic pipette is provided. The electronic pipette comprises a casing 1, a power unit 2 arranged in the casing 1 and providing a linear motion, a drawing/draining unit 3 arranged on one end of the casing 1 and driven by the power unit 2, a pressing unit 4, a signal generator 52 for sensing the pressing of the pressing unit 4 and outputting a corresponding signal, and a controller 6.

Step 602: An electrical displacement signal corresponding to manual operation and moving stroke is generated, where the signal generator 52 detects the pressing operation and pressing stroke of the pressing unit and outputs the electrical displacement signal to the controller 6.

Step 604: A continuous control signal is generated according to the displacement signal, where the controller 6 calculates the displacement signal to obtain the continuous control signal and sends the continuous control signal to the power unit 2.

Step 606: The electronic pipette is controlled by the control signal such that the drawn/drained amount is proportional to the operation stroke. Moreover, the drawn/drained amount is preferably in direct proportion to the operation stroke. In other word, the drawn/drained amount is large when the operation stroke is large; the drawn/drained amount is smaller when the operation stroke is small. The proportion relationship is preferably linear.

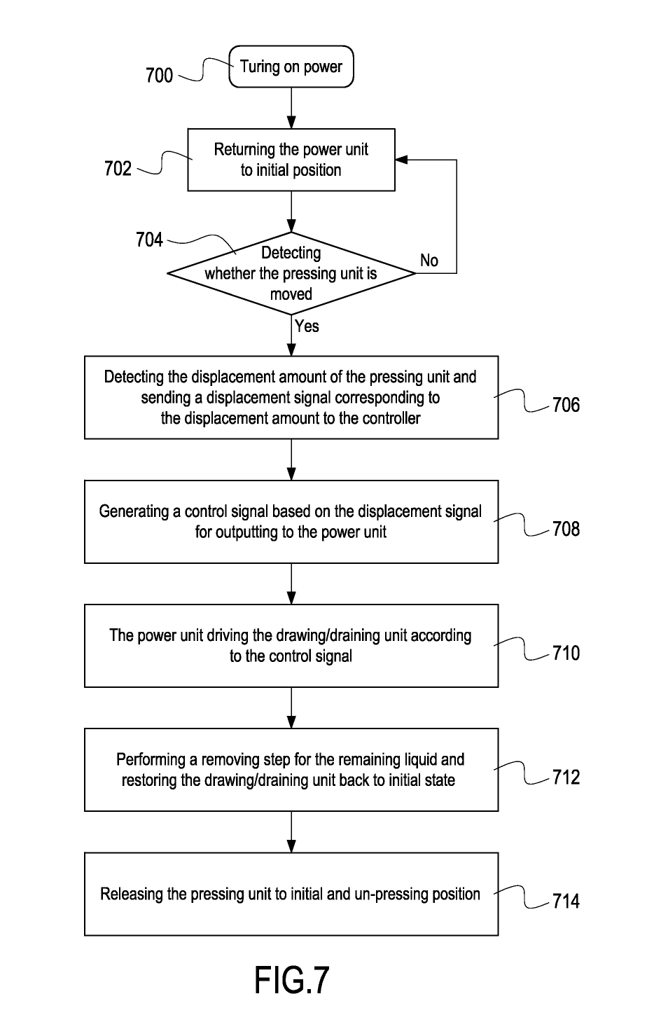

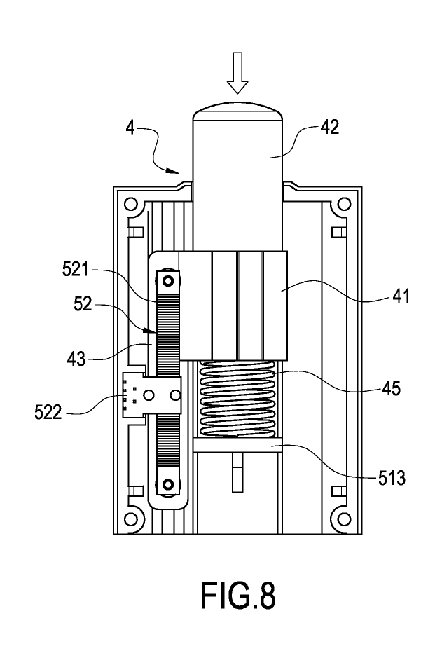

FIG. 7 shows the flowchart of stroke detection according to a preferred embodiment of the present invention, and FIG. 8 is a schematic drawing showing the electronic pipette in stroke detection.

Step 700: The power is turned on.

Step 702: The power unit is returned to an initial position for drawing/draining operation.

Step 704: The signal generator 52 detects whether the pressing unit 4 is moved by manual operation.

Step 706: The signal generator 52 detects the pressing of the pressing unit and senses the displacement amount of the pressing unit 4 and the main grating scale 521. The movement signal generator 52 generates a displacement signal corresponding to the displacement amount to the controller.

Step 708: The processor 61 of the controller 6 generates a control signal based on the displacement signal and corresponding to the displacement amount of the drawing/draining operation and outputs the control signal to the power unit 2. The calculated drawing/draining amount is shown in the display 62.

Step 710: The power unit 2 is driven by the control signal to drive the drawing/draining unit 3 for a linear displacement corresponding to the displacement signal.

Step 712: A removing step is performed for the remaining liquid and the power unit 2 controls the drawing/draining unit 3 back to the initial state to wait for next manual operation.

Step 714: The manual pressing for the pressing unit 4 is released, where the pressing unit 4 is back to the initial and un-pressing position by the resilient force of the resilient member 45.

The drawing/draining operation of the drawing/draining unit 3 driven by the power unit 2 is directly responsive to the manual displacement amount of the pressing unit 4 sensed by the signal generator 52. Therefore, a linear and stepless control analog to manual operation can be provided.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An electronic pipette real-time responsive to manual operation, comprising:
a pressing unit comprising an automatic-restoring button;
a signal generator detecting a pressing operation and a displacement amount of the button and generating a displacement signal corresponding to the displacement amount;
a controller connected to the signal generator and receiving signal from the signal generator, the controller generating a control signal based on the displacement signal;
a power unit connected to the controller and controlled by the control signal; and
a drawing/draining unit connected to the power unit to perform drawing/draining operation driven by the power unit.

2. The electronic pipette as in claim 1, wherein the signal generator is a displacement sensor.

3. The electronic pipette as in claim 1, wherein the displacement sensor is a linear scale.

4. The electronic pipette as in claim 3, wherein the displacement sensor is a linear scale comprises a main grating scale and an optical detector and the main grating scale is connected to the button and linked with the button, the displacement amount of the button is detected by relative movement of the main grating scale and the optical detector.

5. The electronic pipette as in claim 1, wherein the controller comprises:
a processor connected to the power unit and the signal generator, the processor receives displacement signal from the signal generator and outputs a control signal to the power unit; and
a display connected to the processor and show related information.

6. The electronic pipette as in claim 5, wherein the processor calculates a drawing/draining amount of liquid and shows the drawing/draining amount of liquid through the display.

7. A method for controlling an electronic pipette real-time responsive to manual operation, comprising:
providing an electrically-controllable drawing/draining unit;
generating a displacement signal corresponding to a manual operation;
generating a continuous control signal according to the displacement signal; and
controlling the electrically-controllable drawing/draining unit by the continuous control signal, whereby a drawing/draining amount of liquid is in proportional relationship to a stroke of the manual operation.

8. The method as in claim 7, wherein the displacement signal of the manual operation is a displacement signal corresponding to the stoke of the manual operation.

9. The method as in claim 7, wherein the proportional relationship is a direct proportional relationship.

10. The method as in claim 9, wherein the direct proportional relationship is a linear proportional relationship.
